(19) United States
(12) Patent Application Publication
(10) Pub. No.: US 2017/0172836 A1
(43) Pub. Date: Jun. 22, 2017

(54) JOINT REHABILITATION APPARATUS

(71) Applicant: George E. Johnson, SR., Rosharon, TX (US)

(72) Inventor: George E. Johnson, SR., Rosharon, TX (US)

(21) Appl. No.: 15/369,552

(22) Filed: Dec. 5, 2016

Related U.S. Application Data
(60) Provisional application No. 62/263,124, filed on Dec. 4, 2015.

(51) Int. Cl. A61H 1/02

(52) U.S. Cl. CPC A61H 1/02; A61H 1/0255; A61H 1/0237; A61H 1/0229; A61H 1/024; A61H 1/0244; A61H 1/0266; A61H 2203/0481; A61H 2201/164; A61H 2201/1642

(57) ABSTRACT

An apparatus and method for rehabilitating a joint of a user is provided. The apparatus includes a modular frame configured to support the joint in a predefined position. A plurality of pulleys are adjustably coupled to one or more locations on the modular frame. A plurality of cords pass through the plurality of pulleys and couple to opposing ends of a boot. The boot surrounds a portion of the user distal to the joint. The plurality of cords permit a user to actuate the joint through a full range of motion. The user may selectively apply either a resistive force or an assistive force through the one or more cables to affect the joint through its range of motion.

### CLAIM OF PRIORITY

This application claims the benefit of U.S. Provisional Application No. 62/263,124 filed 4 Dec. 2015. The information contained therein is hereby incorporated by reference.

### BACKGROUND

1. Field of the Invention

The present application relates generally to medical rehabilitation devices, and in particular to an apparatus for rehabilitating the knee.

2. Description of Related Art

A plurality of different types of medical devices are known on the market. Each has an assortment of verifiable deficiencies. With respect to joint rehabilitation, such deficiencies can be the inability to permit a full range of motion during rehabilitation. Others include no dynamic exercises or a failure to permit assistant to the moving joint or resistance. Some devices are electrically powered and/or are not portable for ease of transportation or set up. Light weight, ease of transportation, storage, and assembly are all typically key factors for those needing joint rehabilitation. A failure to be portable requires users to travel for rehab, thereby preventing the user to adjust and rehab at his/her own pace and frequency.

Although great strides have been made over the years in medical devices, a portable joint rehabilitation device overcoming the above deficiencies is needed.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of a joint rehabilitation apparatus according to an embodiment of the present application;

FIG. 2 is a side view of a frame of the apparatus of FIG. 1;

FIG. 3 is a front view of a pulley end support used within the frame of FIG. 2;

FIG. 4 is a front view of a leg end support used within the frame of FIG. 2;

FIG. 5 is a side view of the apparatus of FIG. 1 in a collapsed position;

FIG. 6 is a side view of a plurality of cords used in the apparatus of FIG. 1;

FIGS. 7-8 are side views of the cords of FIG. 6 during rehabilitation; and

FIGS. 9-10 are side views of an alternative routing of the cords of FIG. 6 to perform rehabilitation.

While the application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The apparatus and method of use in accordance with the present application overcomes one or more of the above-discussed problems commonly associated with existing medical rehabilitation devices. Specifically, the apparatus of the present application is configured to provide a modular system designed to allow a user to provide selective resistance, dynamic exercises, and a full range of motion to the joint being rehabilitated. This apparatus is designed further with the idea to accommodate quick and easy assembly and collapsibility. These and other unique features of the apparatus are discussed below and illustrated in the accompanying drawings.

The apparatus will be understood, both as to its structure and operation, from the accompanying drawings, taken in conjunction with the accompanying description. Several embodiments of the apparatus are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The apparatus of the present application includes a modular rigid frame in association with a plurality of pulleys and cords that are selectively located and configured to provide a user the ability to adjust and modify the rehabilitation of a leg through adjustment of resistance, range of motion, the level of user assistance, and an ability to perform flexion of the leg.

Referring now to the figures wherein like reference characters identify corresponding or similar elements in form and function throughout the several views. The following Figures describe apparatus 101 and its associated features to provide an improved joint rehabilitation apparatus. The apparatus of the present application includes a modular frame 103, a plurality of pulleys 105, a plurality of cords 107, and an adjustable boot 109. Frame 103 is configured to support the joint of a user in a predefined position relative to the rest of the body. Pulleys 105 are coupled to various locations on frame 103 and are used to permit cords 107 to be selectively routed to enable a user to rehabilitate the joint over a full range of motion. Boot 109 surrounds a portion of the user's appendage with the joint and is coupled to both cords 107 such that as boot 109 is pulled, the joint is selectively flexed. For exemplary purposes, use of the present apparatus will be described with respect to a leg and rehabilitation of the knee joint. It is understood that this same apparatus may be used on other joints as well.

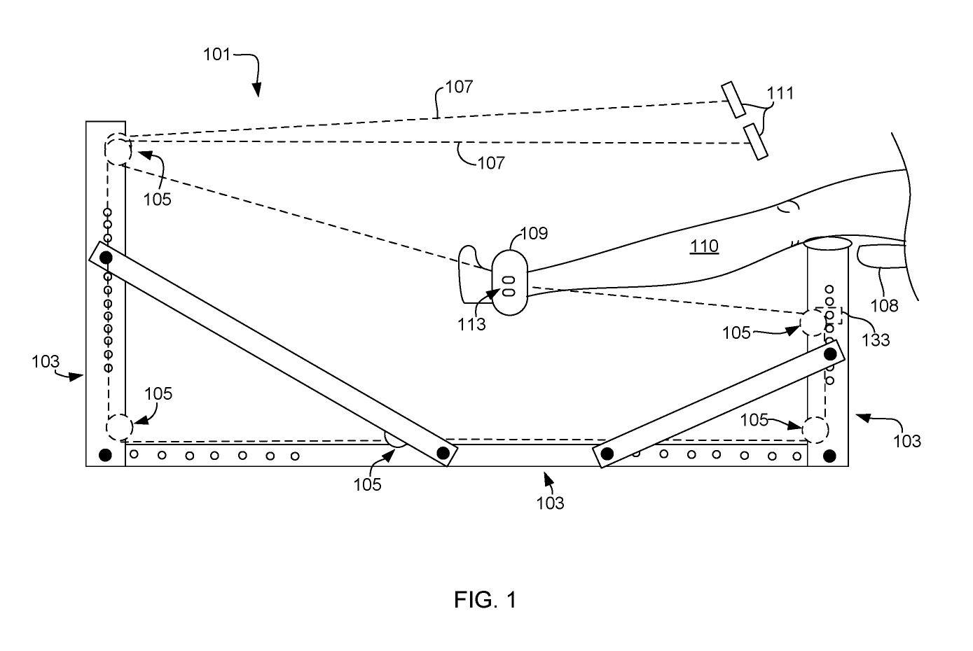

Referring in particular with FIG. 1 in the drawings, apparatus/system 101 is illustrated wherein a user's leg is fully extended. The leg 110 is placed in boot 109. The user is resting on a chair 108 with the leg resting on a portion of frame 103. Cords 107 are attached to boot 109 and pass through one or more pulleys 105. Each cord 107 is coupled to a handle 111 for the user to grip and operate. Through handles 111, the user is able to selectively provide resistance, necessary resistance, during motion of the leg 110. Pulleys 105 are selectively located throughout frame 103 to facilitate differing motions of leg 110 and provide the ability to permit different ranges of exercises. As seen in FIG. 1, boot 109 may further include one or more removable weights configured to releasably couple to a portion of boot 109. Weights 113 may be interchanged to adjust weight. Additionally, weights may be located in a plurality of locations to allow for the user to customize the location of the weight in relation to the leg.

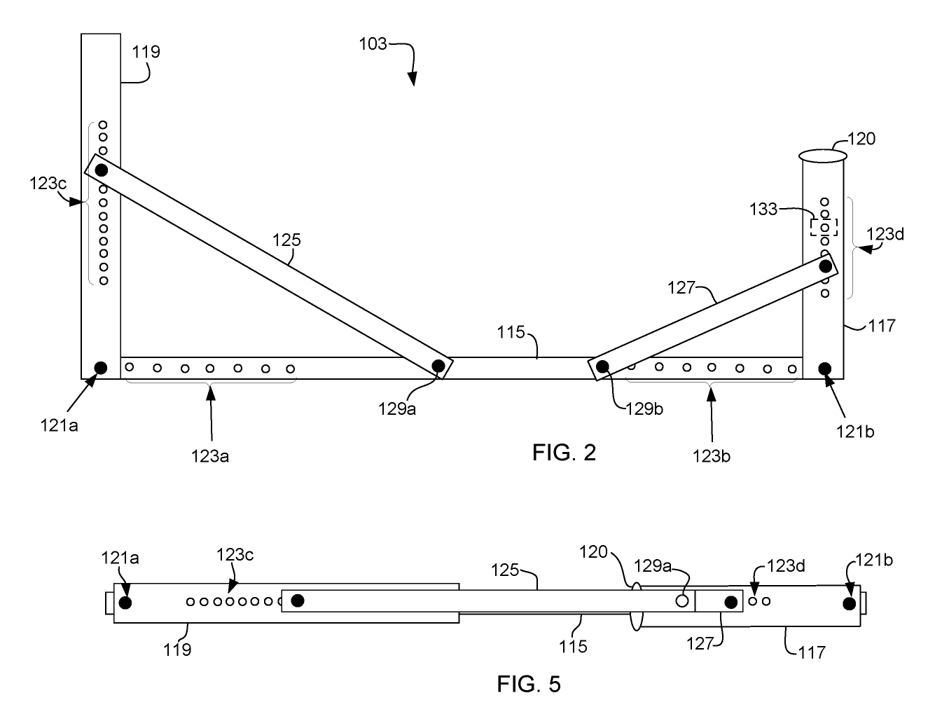

Referring now to FIGS. 2-5 in the drawings, frame 103 is further illustrated. Frame 103 is configured to provide a rigid structure to support the weight of leg 110 and the available range of motion exhibited by leg 110 through the plurality of potential exercises. To do this, frame 103 includes a base portion 115, a leg end portion 117, and a pulley end portion 119. Frame 103 is made from durable resin based plastic or metallic material that is not susceptible to absorption of liquids (i.e. aluminum and hardened plastics for example). It is important for frame 103 to maintain an ease of cleanability and good hygiene. Other stable and rigid materials are contemplated.

Portions 117 and 119 are configured to couple to base portion 115 at opposing ends. Attachment locations 121a and 121b are illustrated with a fastener being used to releasably couple portions 117 and 119 to base 115. Fasteners used may be threaded fasteners with associated washers and nuts. Fasteners may be loosened upon completion of exercises to allow portions 117 and 119 to pivot about attachment locations 121a and 121b for collapsing as seen in FIG. 5. Other types of fastening devices are contemplated, such as pins, quick release fasteners, snap fit interference fasteners and so forth.

Base portion 115 further includes adjustment slots 123a and 123b. Adjustment slots 123a are used to permit the user to selectively locate the position of pulley end support 119 along base 115. Likewise, adjustment slots 123b are used to permit the user to selectively locate the position of leg end support 117 along base 115. The ability to adjust the distance between portions 117 and 119 in relation to base 115 is important. It is understood that the size of user's may vary. By permitting the separation of portions 117 and 119 to vary, apparatus 101 is customizable to different sized users. This helps to locate the user's leg in proper position with the plurality of pulleys 105. A pad 120 is located on top of portion 119 for the comfort of the user's leg 110.

Frame 103 may further include one or more support braces 125 and 127. Braces 125 and 127 are provided to increase the rigidity of frame 103 when subjected to the stresses and forces of rehabilitation. The necessity of braces 125 and 127 may be dependent upon the type of connection between portions 117 and 119 at attachment locations 121a and 121b. Much like the use of adjustment slots 123a and 123b, braces 125 and 127 are associated with separate adjustment slots 123c and 123d found in portion 119 and portion 117 respectively. Attachment slots 123c and 123d are provided to permit braces 125 and 127 to adjust to the varied location of portions 117 and 119 along attachment slots 123a and 123b. As portions 117 and 119 translate along base 115, the relative angle of braces 125 and 127 in relation to base 115 are changed. It is understood that the braces 125 and 127 may pivot about attachment locations 129a and 129b respectively. During collapsing of frame 103, braces 125 and 127 are permitted to pivot about one of the attachment locations to permit the collapsing of the various portions of frame 103 in an organized manner as seen in FIG. 5. Much like with fasteners located with attachment locations 121a and 121b, fasteners associated with braces 125 and 127 are similar in form and function so as to permit quick adjustment and ease of use.

As seen in FIG. 5, frame 103 is illustrated in a collapsed relationship. It is understood that the illustrated layout is exemplary in nature and may vary depending on design constraints. Apparatus 101 is configured to collapse so as to lie within a single plane to assist in the portability, storage, and handling of apparatus 101.

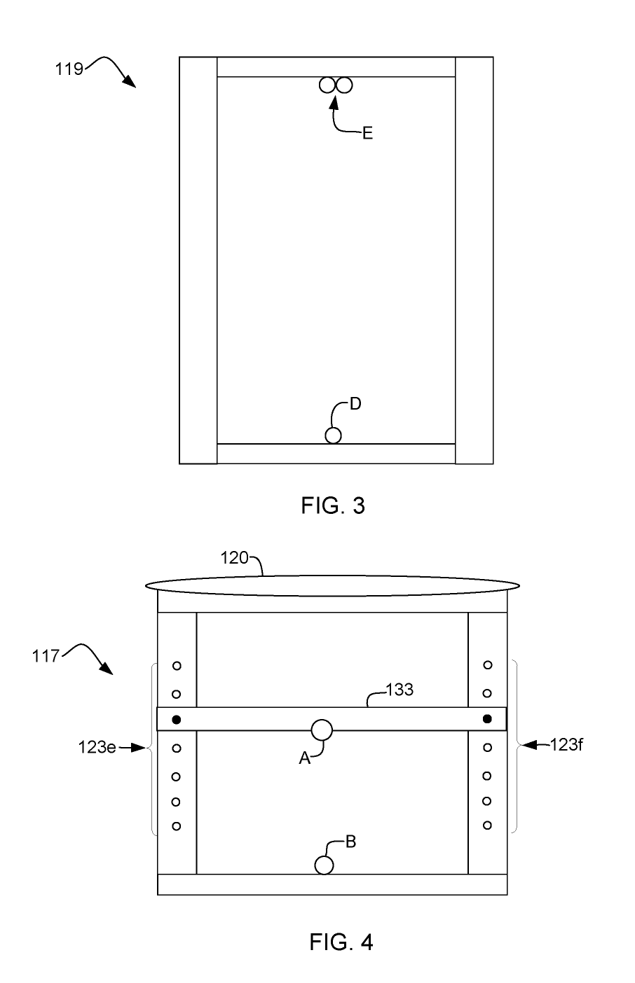

Referring now also to FIG. 3 in the drawings, pulley end portion 119 is illustrated from the front. As seen, portion 119 is simply a rectangular structure having attachment locations for one or more pulleys 115. References to pulleys 115 will be made with a single letter identifier (i.e. A, B, C, D, and E) from here on in the application. Discussion related to pulleys in general will continue to use the numerical identifier “115”. Pulleys D and E are shown coupled to portion 119. Pulley E is a double pulley or may be a combination of two individual pulleys.

Referring now also to FIG. 4 in the drawings, leg end portion 117 is illustrated from the front. Portion 117 is a rectangular structure having attachment locations for one or more pulleys 115. In particular, pulley A and pulley B. Pulley A is located on a flexion support member 133. Member 133 is configured to releasably couple to portions of the side structure via attachment slots 123e and 123f. The variable height feature permits the user to adjust the angle of tension to the size of their leg 110.

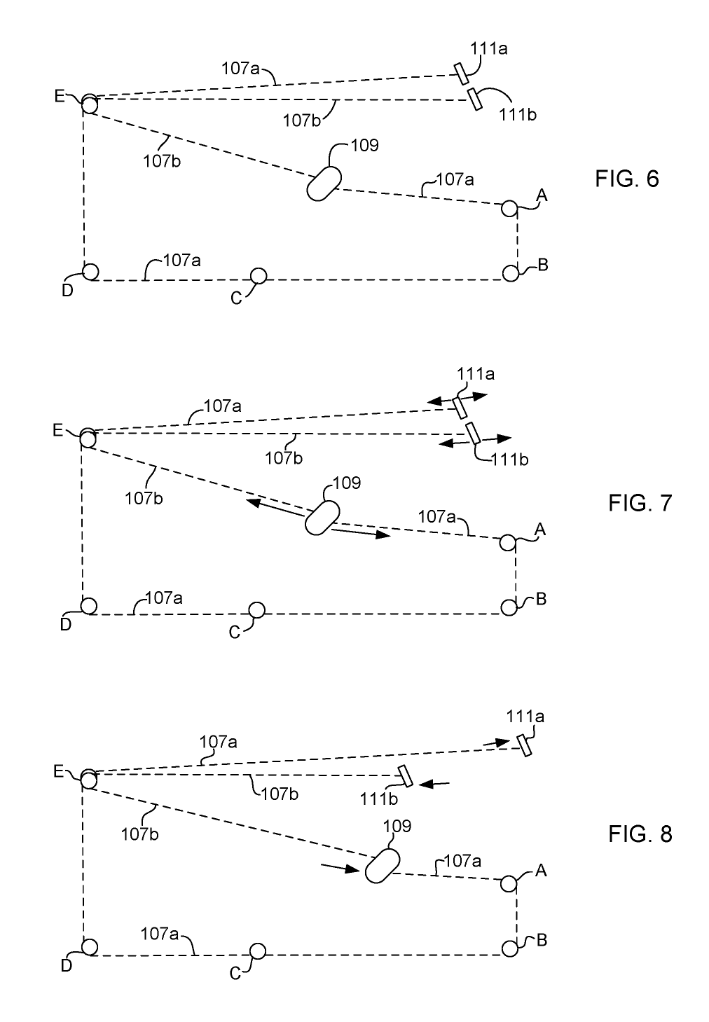

Referring now also to FIGS. 5-10 in the drawings, cords 107 are illustrated with relation to the pulleys 115 only. Frame 103 has been removed for ease of visual identification. Two individual cords are used with apparatus 101, namely cord 107a and cord 107b. Cords 107a and 107b are individually and separately attached to handles 111a and 111b respectively. Each cord 107a and 107b is routed through one or more pulleys 115 to provide attachment to opposing ends of boot 109. As illustrated in the figures, cord 107a is routed through pulleys E, D, C, B, and A. Cord 107b is routed through pulley E. The user is able to grip handles 111a and 111b and provide any one of resistance and/or assistance to leg 110. The use of resistance and/or assistance helps to aid in the completion and performance of rep movements. FIGS. 6-10 illustrate the various movements of boot 109 as cord 107a and 107b are pulled by a user.

In particular with FIG. 7, a representative neutral position of boot 109 is illustrated. The arrows show the directions which boot 109 and handles 111a and 111b may be moved. FIG. 8 illustrates the movement when boot 109 is moved closer to pulley A. In this illustration, leg 110 was flexed into a bent position, thereby moving boot 109. In doing so, cord 107b and handle 111b moved in the direction indicated by the arrows, while conversely cord 107a and handle 111a moved in the opposite direction. During this movement, the user may have applied a resistive force on cord 107b or may have applied an assistive force with cord 107a. As leg 110 flexes between extended or retracted (bent) positions, cords 107 move in opposing directions with boot 109 and the user is able to apply resistive and assistive forces to assist in rehabilitation of the leg joint.

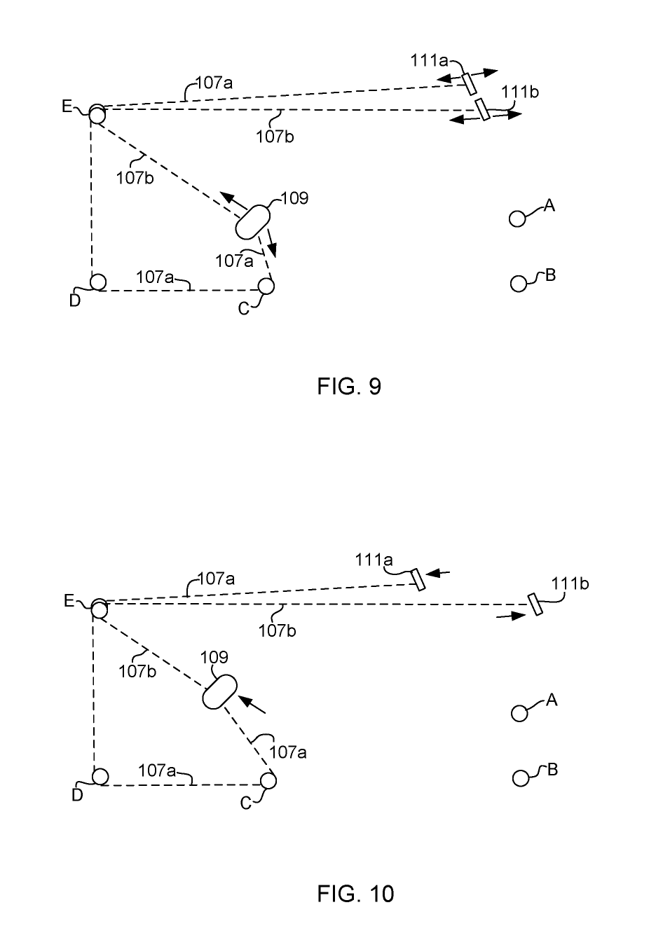

FIGS. 9 and 10 illustrated the ability for a user to adjust which pulleys 115 are used. In FIGS. 9 and 10, cord 107a is routed through pulley E, D, and C only. As seen with FIG. 6, the representative neutral location of boot 109 is illustrated in FIG. 9, while movement of a portion of leg 110 moves boot 109 to a secondary position in FIG. 10. The respective location changes of boot 109 and handles 111a and 111b are illustrated. It is understood that the length of cords 107a and 107b are also optionally configured to extend or shorten depending on the type of exercises performed and the precise routing through the pulleys 115. The lengthening or shortening of the cords may occur at the handles 111 or at boot 109. Additionally it is understood that a plurality of exercises may be performed by adjusting the routing of cords 107. Multiple joints with the leg 110 may be rehabilitated (i.e. hip, knee, ankle . . .).

It is important to note that advantages of apparatus 101 allow for joint rehabilitation to be performed anywhere. The transportability of apparatus 101 allows for use at home or work. Apparatus 101 is configured to maintain a low weight and compact design to permit carrying by a single person. Set-up is streamlined to allow for quick connection of fasteners. A further feature is the adjustability of pulleys 115 on frame 103. Although illustrated in selected positions for illustrative purposes, it is understood that the locations of pulleys 105 may be adjustable to other locations to permit an expanded number of exercise and adapt to the size of the user. Use of apparatus 101 is configured to help with the flexion of leg 110 by permitting rehabilitation activities to be performed in a sitting position and allow for a full range of motion of the leg.

The current application has many advantages over the prior art including at least the following: (1) a modular frame being collapsible and configured for compact storage and transportation; (2) adjustable pulleys; (3) a boot with opposingly attached cords to permit for the application of either of a resistive force or an assistive force through the one or more cables to affect the joint through its range of motion; and (4) ability to add weight to the boot to increase resistance.

The particular embodiments disclosed above are illustrative only and are not intended to be exhaustive or to limit the invention to the precise form disclosed, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A joint rehabilitation apparatus for the rehabilitation of a joint, comprising:
a modular frame configured to support the joint in a predefined position;
a plurality of pulleys coupled to one or more locations on the modular frame;
a plurality of cords passing through the plurality of pulleys; and
a boot coupled to the plurality of cords to permit actuation of a joint;
wherein the plurality of cords permit a user to actuate the joint through a full range of motion.

2. The apparatus of claim 1, wherein the boot includes a removable weight.

3. The apparatus of claim 1, wherein the weight of the boot is adjustable so as to regulate resistance to the joint.

4. The apparatus of claim 1, further comprising:
a support member for resting of the joint.

5. The apparatus of claim 1, wherein the modular frame is coupled by one or more quick release fasteners.

6. The apparatus of claim 1, wherein the user may selectively apply a force either to assist motion or to resist motion of the joint.

7. The apparatus of claim 1, wherein the plurality of cords are configured to permit the application of opposing forces to the joint.

8. A method of rehabilitating a joint, comprising:
providing the apparatus of claim 1;
setting the position of the plurality of pulleys;
orienting the modular frame in relation to the joint; and
actuating the joint between a flexed position and an extended position.

9. The method of claim 8, further comprising:
adding weight to the boot.

10. The method of claim 8, further comprising:
adjusting the weight in the boot.

11. The method of claim 8, further comprising:
increasing resistance to the joint by pulling on at least one of the plurality of cords.

12. The method of claim 8, further comprising:
collapsing the modular frame for transport and storage.

13. The method of claim 8, further comprising:
adjusting the location of at least one pulley.

14. The method of claim 8, wherein the modular frame is configured to include a plurality of slots to change the angle of resistance applied through the cords.

15. The method of claim 8, further comprising:
applying an assistive force to the joint by pulling a first of the plurality of cords.

16. The method of claim 8, further comprising:
applying a resistive force to the joint by pulling a second of the plurality of cords.
